(19) United States
(12) Patent Application Publication
(10) Pub. No.: US 2015/0284054 A1
(43) Pub. Date: Oct. 8, 2015

(54) System and Method Rapid Disconnection of the Drilling Riser of a Floating Drilling Platform

(71) Applicants: Theodore KOKKINIS, Houston, TX (US); Zhong DING, Missouri City, TX (US); Daniel FENZ, Houston, TX (US)

(72) Inventors: Theodore Kokkinis, Houston, TX (US); Zhong Ding, Missouri City, TX (US); Daniel Mark Fenz, Houston, TX (US)

(21) Appl. No.: 14/436,451

(22) PCT Filed: Nov. 22, 2013
(86) PCT No.: PCT/US2013/071516

§ 371 Date: Apr. 16, 2015

Related U.S. Application Data
(60) Provisional application No. 61/745,128, filed on Dec. 21, 2012.

(51) Int. Cl. B63B 22/02; B63B 35/44; F16L 1/26; B63B 3/14

(52) U.S. Cl. CPC B63B 22/02; B63B 3/14; B63B 35/4413; F16L 1/26; B63B 2003/147

(57) ABSTRACT

A system and method for rapidly disconnecting a drilling riser from a floating drilling platform is provided. In one embodiment, the floating drilling platform has a mooring buoy connected to a seabed. The method comprises disconnecting the drilling riser from a subsea component engaged to the seabed, attaching the mooring buoy to the drilling riser, and releasing the mooring buoy and the attached drilling riser from the drilling platform.

### CROSS-REFERENCE TO RELATED APPLICATION

This application claims the benefit of U.S. Provisional Patent Application 61/745,128 filed 21 Dec. 2012 entitled SYSTEM AND METHOD RAPID DISCONNECTION OF THE DRILLING RISER OF A FLOATING DRILLING PLATFORM, the entirety of which is incorporated by reference herein.

### FIELD OF THE DISCLOSURE

Embodiments of the present disclosure relate to the field of offshore drilling operations and, more particularly, to a system and method for rapid disconnection of the drilling riser of a floating drilling platform in the event of oncoming sea ice, icebergs or other hazards.

### BACKGROUND

This section is intended to introduce various aspects of the art, which may be associated with some embodiments of the present invention. This discussion is believed to assist in providing a framework to facilitate a better understanding of particular aspects of the present invention. Accordingly, it should be understood that this section should be read in this light, and not necessarily as admissions of prior art.

Offshore wells supporting oil and gas activities in arctic regions may be drilled from a bottom-founded platform up to a water depth of about 100 m. Beyond this water depth, a floating vessel or platform is needed to drill such wells. A floating drilling platform connected to the seabed by a conventional drilling riser system is depicted in FIG. 1. Platform 101 is positioned in a body of water 103 above the drill site. As depicted, platform 101 comprises a drilling derrick 105, deck 107 and hull 109. A detachable buoy 111 is positioned adjacent to the hull 109 and is connected to the hull 109 by buoy locking mechanisms 119.

As understood by those skilled in the art, while drilling a well, a floating platform 101 is kept on station by a station-keeping system. In the FIG. 1 embodiment, the station-keeping system comprises a plurality of mooring lines 113 held in place by anchors 115 engaged to the seabed 117. Furthermore, a conventional top-tensioned vertical access drilling riser 121 connects the platform 101 to the head of the well, which includes a Blow-Out Preventer (BOP) 127 positioned at the seabed 117, via a connector included in a Lower Riser Marine Package (LMRP) 125. As understood by those skilled in the art, riser 121 is comprised of several, individual riser joints 123. Top joints 131 allow for the drilling riser to be attached to the platform. Top joints 131 may include, but are not limited to, a telescopic joint 131a, flex joint/riser diverter 131b.

In arctic offshore areas, ice is expected to drift across the drilling location for a large part of the year, or even throughout the year, imparting heavy ice loads on the drilling platform 101. In severe ice conditions, these loads can frequently exceed the capacity of the platform's mooring system. To ensure that the mooring lines 113 and the drilling riser 121 are not damaged in such conditions, one approach is to safely suspend operations, retrieve the riser and disconnect the mooring buoy, and reconnect them again when the ice conditions improve. While the mooring is disconnected the platform 101 may drift away from the drilling location under the action of the drifting ice. This is depicted in FIG. 2 in which arrow 201 refers to the drift direction.

Because of the expected high number of such disconnections and reconnections, these actions have to be performed rapidly. One known technique for rapid disconnection and reconnection of the mooring system of a platform 101 is to have all mooring lines 113 connected to mooring buoy 111. Such a configuration typically leads to a quick disconnection or reconnection of the platform 101 from its mooring system—typically of the order of a fraction of an hour.

When it is necessary to disconnect the mooring system from the platform 101, the buoy 111 carrying the mooring lines 113 is released from the hull 109 through the operation of locking mechanisms 119. The disconnection operations of such a system require a much shorter time than it would if the mooring lines had to be disconnected individually. The same is true for the reconnection: the buoy 111 is pulled back in position within the hull 109 of the platform 101 and mechanically locked there with locking mechanisms 119. As known by those skilled in the art, the buoy 111 is designed to float after disconnection at a depth sufficient to avoid contact with any ice features drifting overhead, i.e., keels of sea ice ridges or icebergs.

In the case of a drilling platform 101 so equipped with a mooring buoy 111, the marine drilling riser 121 connecting the main body of the platform to the wellhead is routed through an opening in the middle of the mooring buoy 111 called a moon pool 129. This means that before the mooring buoy 111 can be disconnected so that the platform 101 can be relocated, it is necessary to disconnect the riser 121 at the LMRP 125 above the BOP 127 and retrieve the riser to the platform 101 in order to clear the mooring buoy 111, as shown in FIG. 2.

Otherwise there would be interference between the drilling riser 121 and the mooring buoy 111, likely to result in damage to both. An example of such an instance is depicted in FIG. 3 in which circle 201 identifies the potential interference between riser 121 and buoy 111. In FIG. 3, the mooring buoy 111 is disconnected from drilling platform 101 so that the platform may drift in direction 301. However, though drilling riser 121 is disconnected from the BOP 127 at the LMRP 125, it is still attached to the platform 101. Therefore, as the platform drifts away from the drill site, the riser 121 may impact the buoy 111, thereby resulting in damage to the buoy or the riser or both.

It should be noted that unlike compliant non-vertical oil and gas production risers, whose compliance allows them to be connected directly to the buoy and move with the buoy as the latter is dropping in the water column when disconnected, vertical marine drilling risers 121 are normally tensioned using a riser tensioner 133 acting between the deck 107 of the platform 101 and the lower barrel of a telescopic joint (one of top joints 131). Compliance in the tensioned riser 121 would cause it to buckle and be damaged as buoy 111 is dropped, particularly if there is clashing between the buoy 111 and riser 121.

However, pulling the entire drilling riser 121 up to the deck 107 of the platform 101 takes a considerable amount of time, because the riser 121 has to be disassembled joint-by-joint as it is being pulled up and set back on the platform. As an example, in a water depth of 1000 m, it is estimated that the operation of pulling a drilling riser up to the platform would take approximately 20-30 hours, a much longer time than that required to disconnect the mooring buoy under severe ice conditions. A similarly long time would be needed to redeploy the riser 121 after reconnecting the mooring buoy 111. Thus a clear need exists for a method and/or system that would significantly shorten the time needed to ensure no interference between the mooring buoy and the drilling riser during a disconnection operation.

A potential solution for avoiding the need to pull the entire riser 121 up to the main body of the platform 101 and avoiding interference with the mooring buoy 111 during disconnection is to split the riser into a lower part 401 and an upper part 403, as shown in FIG. 4. The lower part 401 may be supported by one or more buoyancy cans 405 at the top. The upper part 403 has a riser joint with a connector 407 at its lower end which normally keeps it connected to the lower part 401. The connector on riser joint 407 may be released to separate the upper riser section 403 from the lower riser section 401.

During a disconnection, the upper part 403 of the riser is disconnected from the lower part 401 and then retrieved and stowed in the platform 101 as depicted in FIG. 5. The mooring buoy 111 can then be disconnected so that the platform 101 may drift away. While such a system does achieve the objective of saving part of the time needed to retrieve the entire riser up to the platform, it still has certain disadvantages. For example, because the riser has two parts, one of which is intended to stay as a free-standing riser in the water column after disconnection, it requires special engineering considerations for motion, stability and structural design, different from conventional single-part drilling risers. Also, because the lower part of the riser after disconnection has to be below the mooring buoy (to avoid interference between the buoy and the riser during disconnection) and the mooring buoy has to come to rest at a depth sufficient to avoid contact with keels of ice ridges and/or icebergs, the length of the upper part of the riser may be a substantial portion of the total length of the riser. Thus the time savings from partial riser retrieval may not be as significant.

Further, even if the resting depth of the mooring buoy is above the top of the lower part of the riser, there is potential for interference between the mooring line 113 and the lower part of the riser 401 and/or the buoyancy can 405 during disconnection. The potential interference may occur when the disconnection occurs with the platform 101 at a significant offset from the wellhead. This example is illustrated in FIG. 6. Additionally, the interference with the buoyancy can 405 may occur due to transient vibration of the mooring buoy 111 as it is lowered.

Thus, there is a need for improvement in this field.

### SUMMARY OF THE INVENTION

The present disclosure provides a system and method for rapid disconnection of a drilling riser.

One embodiment of the present disclosure is a method for disconnecting a drilling riser of a floating drilling platform, the floating drilling platform having a mooring buoy connected to a seabed, the method comprising: disconnecting the drilling riser from a subsea component engaged to the seabed; attaching the mooring buoy to the drilling riser; and releasing the mooring buoy and the attached drilling riser from the drilling platform.

The foregoing has broadly outlined the features of one embodiment of the present disclosure in order that the detailed description that follows may be better understood. Additional features and embodiments will also be described herein.

### BRIEF DESCRIPTION OF THE DRAWINGS

The present invention and its advantages will be better understood by referring to the following detailed description and the attached drawings.

FIG. 1 is a cross-sectional side view of an artic floating drilling platform which is kept on station by a mooring system and connected to a subsea well by a top-tensioned vertical access drilling riser as known in the prior art.

FIG. 2 is a cross-sectional side view of the drilling platform of FIG. 1 released from the mooring system as known in the prior art.

FIG. 3 is a cross-sectional side view of the drilling platform of FIG. 1 released from the mooring system without the riser being retrieved as known in the prior art.

FIG. 4 is a cross-sectional side view of a drilling platform and mooring system, in which the drilling platform is utilizing a two-part drilling riser, as known in the prior art.

FIG. 5 is a cross-sectional side view of the drilling platform and mooring system of FIG. 4 in which the upper portion of the riser has been retrieved as known in the prior art.

FIG. 6 is a cross-sectional side view of the drilling platform and mooring system of FIG. 4 in which a mooring line has interfered with the riser as known in the prior art.

FIG. 7 is a flow chart showing the basic steps of mooring buoy and drilling riser connection and release process according to one embodiment of the present disclosure.

FIG. 8 is a cross-sectional side view of a drilling platform and mooring system according to one embodiment of the present disclosure.

FIG. 9 is a cross-sectional side view of the drilling platform and mooring system of FIG. 7 in which joints from the riser have been retrieved according to one embodiment of the present disclosure.

FIG. 10 is a cross-sectional side view of the drilling platform and mooring system of FIG. 8 in which a riser clamp has been engaged according to one embodiment of the present disclosure.

FIG. 11 is a cross-sectional side view of the drilling platform and mooring system of FIG. 9 in which the mooring buoy has been released from the hull according to one embodiment of the present disclosure.

FIG. 12 is a partial, cross-sectional side view of a riser clamp according to one embodiment of the present disclosure.

FIG. 13 is a partial top view of the riser clamp embodiment of FIG. 12.

FIG. 14 is a cross-sectional side view of a riser clamp according to a further embodiment of the present disclosure.

FIG. 15 is an enlarged, partial side view of the riser clamp embodiment of FIG. 14.

It should be noted that the figures are merely examples of several embodiments of the present invention and no limitations on the scope of the present invention are intended thereby. Further, the figures are generally not drawn to scale, but are drafted for purposes of convenience and clarity in illustrating various aspects of certain embodiments of the invention.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

Embodiments of the present disclosure provide a solution to the problem of reducing the time needed to retrieve a drilling riser in order to move the drilling platform and avoiding interference between the riser and a mooring buoy when the latter is disconnected from the drilling platform.

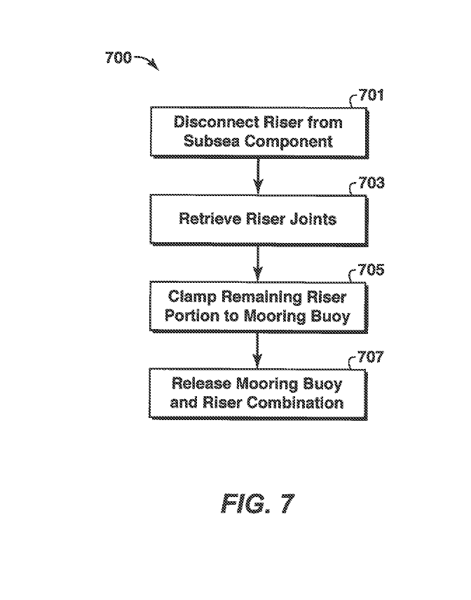

The flowchart of FIG. 7 will be referred to in describing one embodiment of the present disclosure for connecting and releasing a mooring buoy and drilling riser. The depicted process 700 begins by disconnecting the drilling riser from a subsea component (block 701). The mechanisms and components capable of connecting and disconnecting a drilling riser to a wellhead are well known in the art. In one embodiment, a connection within an LMRP is used to release a drilling riser from a BOP.

At block 703, a portion of the riser joints comprising the drilling riser are retrieved. In some embodiments, a diverter, flex joint, telescopic joint and/or a plurality of other riser joints may be retrieved. The number of riser joints retrieved may be based on a variety of factors, such as, but not limited to, environmental conditions, ice conditions, the height of the BOP and the mooring system.

At block 705, the remaining riser is clamped to the mooring buoy. A variety of mechanisms may be utilized to attach the drilling riser to the mooring buoy. Two embodiments of the present disclosure are provided herein below. Once the mooring buoy and riser are connected, the mooring buoy and riser combination may be released into the water column (block 707). In one embodiment, the number of joints removed from the riser in block 703 is predicated upon allowing the mooring buoy and riser combination to drop to a depth sufficient to avoid contact with the icebergs or other ice or hazardous features drifting overhead, while also providing sufficient clearance between the lowest part of the riser and any subsea equipment provided near the drill site.

It is important to note that the blocks depicted in FIG. 7 are provided for illustrative purposes only and a particular block may not be required to perform the inventive methodology. The claims, and only the claims, define the inventive system and methodology.

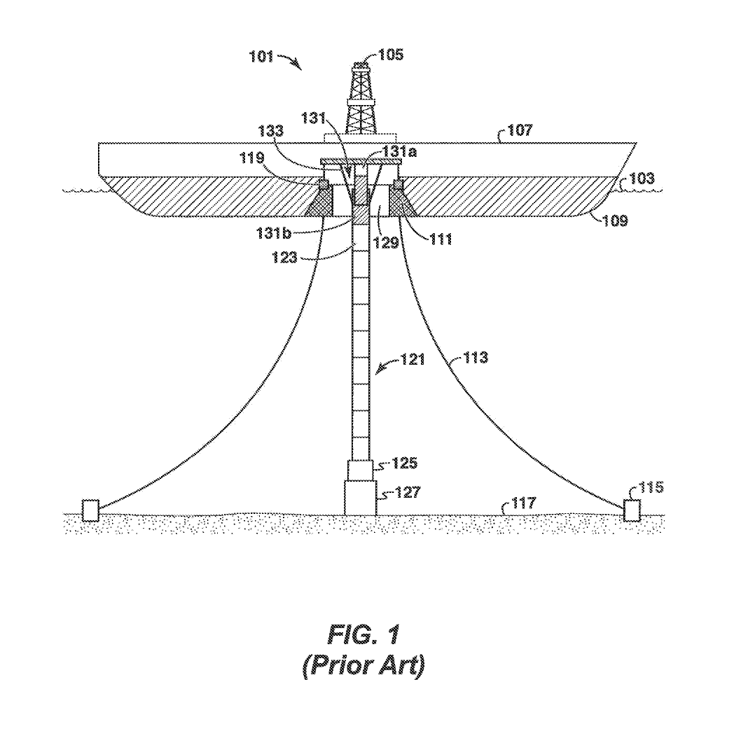

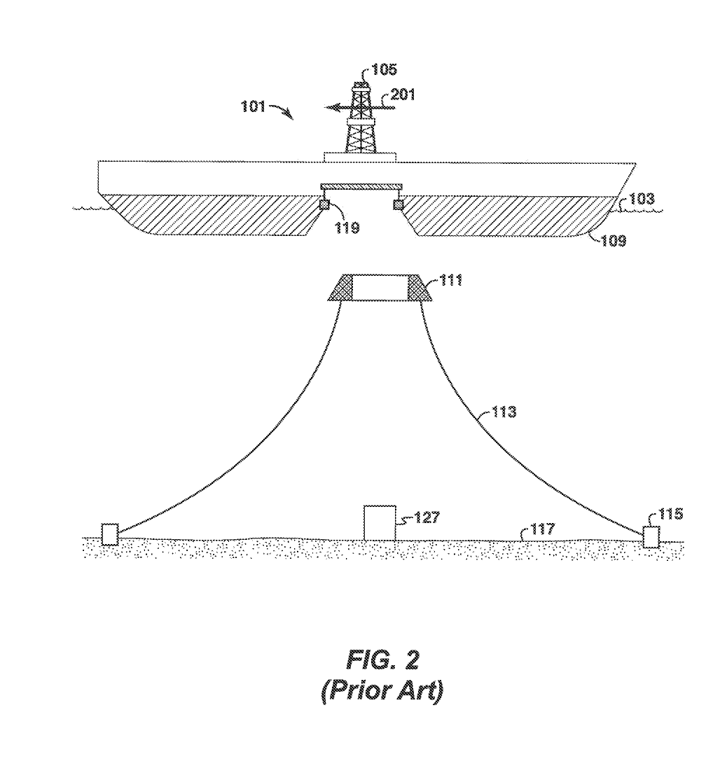

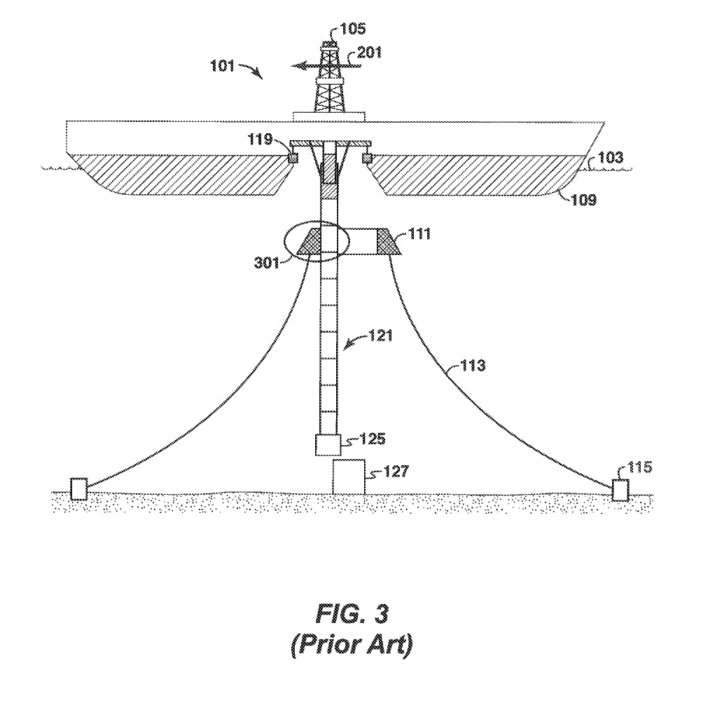

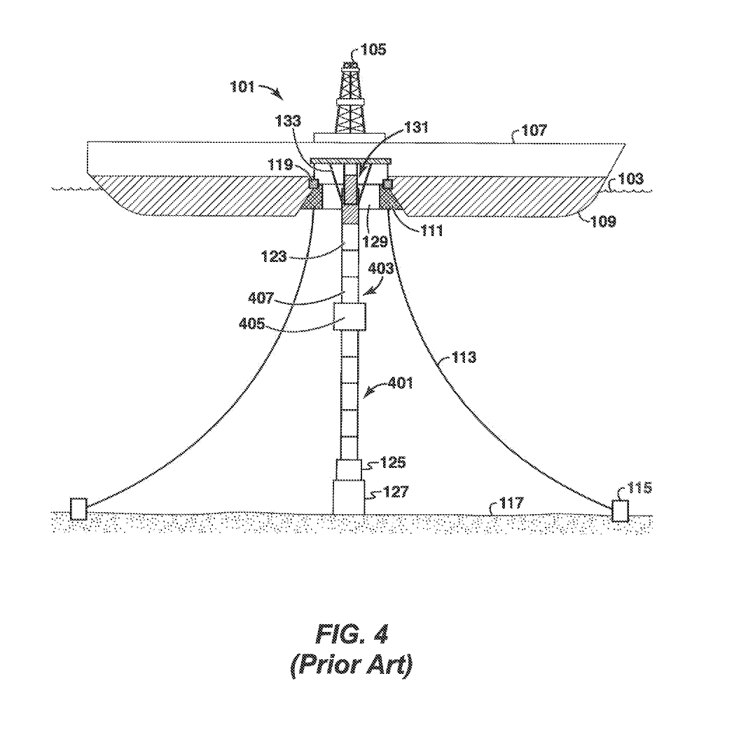

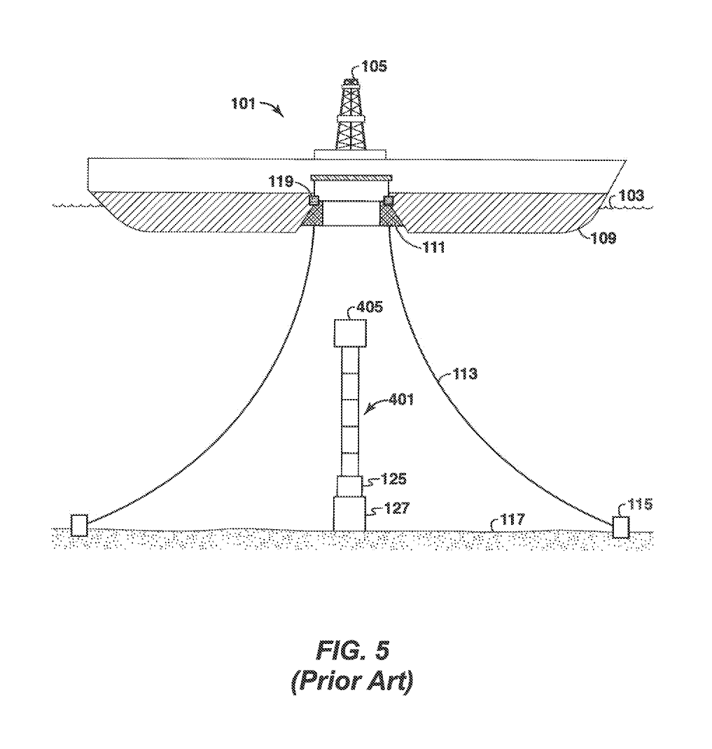

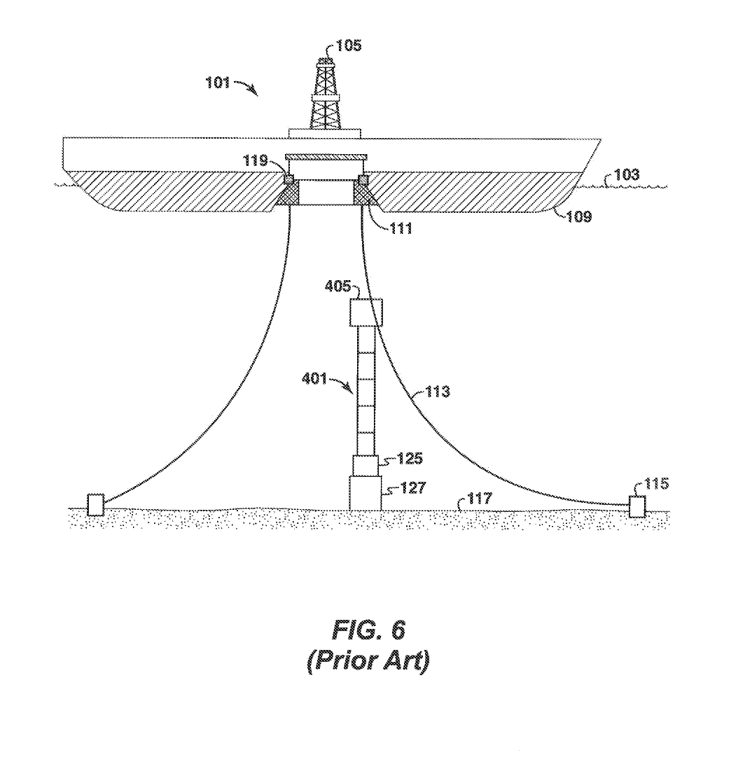

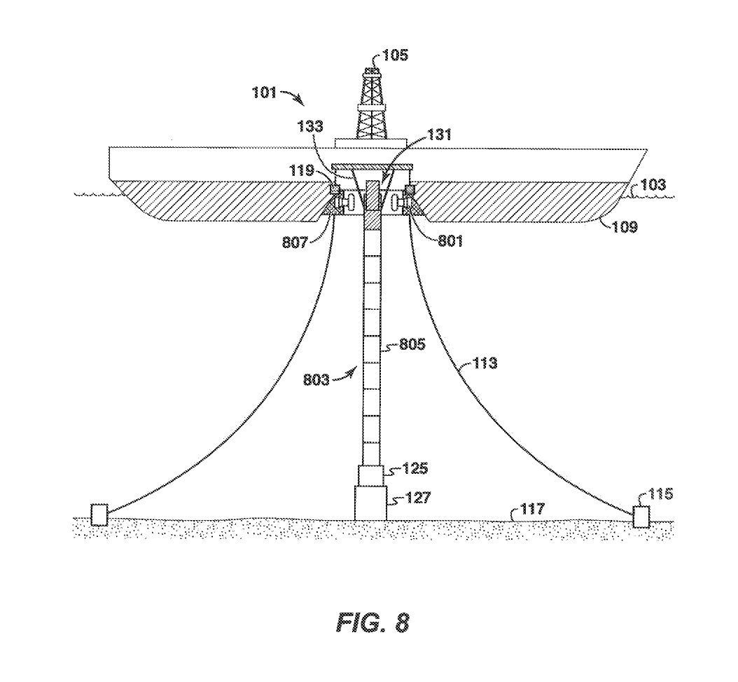

FIG. 8 is a cross-sectional side view of a drilling platform and a mooring system according to one embodiment of the present disclosure. The drilling platform and mooring system depicted in FIG. 1 contain many of the same components depicted in FIG. 1. Platform 101 is positioned in a body of water 103 above a drill site. Platform 101 is kept in station through the use of a plurality of mooring lines 113 held in place by anchors 115 engaged to the seabed 117.

Like FIG. 1, a detachable mooring buoy 807 is positioned adjacent and is connected to the hull 109 by buoy locking mechanisms 119. Through operation of locking mechanisms 119, the mooring buoy 807 is releasably connected to the hull 109. Unlike FIG. 1, a riser clamp 801 is attached to the exterior of detachable buoy 807. Riser clamp 801 is constructed and arranged to firmly attach the riser 803 to the mooring buoy 807. However, in FIG. 8, riser clamp 801 is depicted in its disengaged position thereby allowing riser 803 to freely move relative to the mooring buoy 807. The riser clamp 801 will be discussed in greater detail below.

As depicted, a drilling riser 803 connects the platform 101 to the head of a well, which includes BOP 127 positioned at the seabed 117, via a connector included in a LMRP 125. Riser 803 is comprised of several, individual riser joints 805. According to one embodiment of the present disclosure, riser joints 805 may include connection mechanisms which enable a firm engagement between the riser joint 805 and the riser clamp 801 when the riser clamp 801 is deployed or engaged. In one embodiment of the present disclosure, drilling riser 803 is a conventional drilling riser, such as, but not limited to, a top-tensioned drilling riser. In the embodiment depicted in FIG. 8, no facilities are provided for disconnection of the riser at mid-depth.

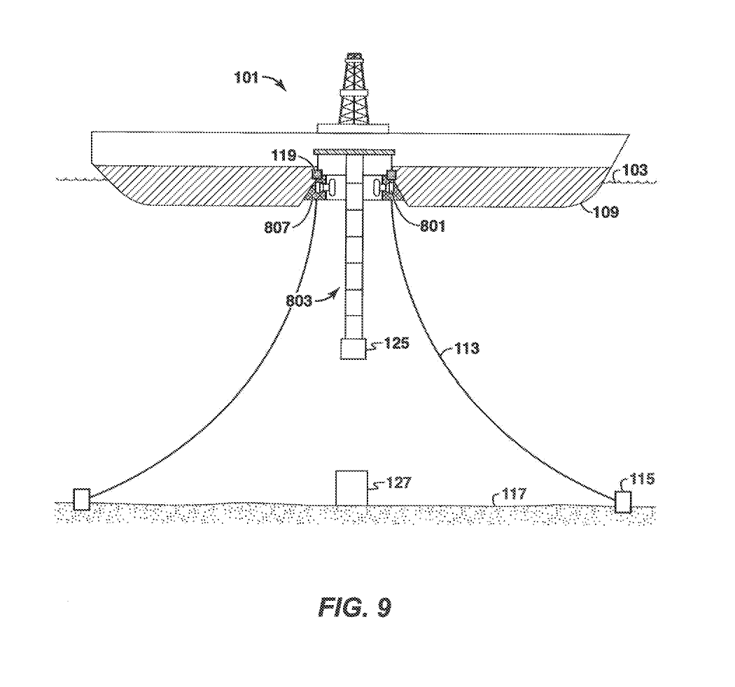

As described herein, there are conditions in which a drilling platform must move in order to avoid damage due to the action of the ice or other hazards. FIG. 9 depicts an early stage in the process of preparing the platform for movement to another location. FIG. 9 is a cross-sectional side view of the drilling platform 101 and associated mooring system as depicted in FIG. 8. As demonstrated, the riser 803 has been disconnected from the BOP 127 at the LMRP 125 after the drilling operations have been safely suspended. Further, top joints 131, riser tensioner 133 and a few of the riser joints 805 have been retrieved. In the FIG. 9 embodiment, the mooring buoy 807 is still connected to the platform hull 109.

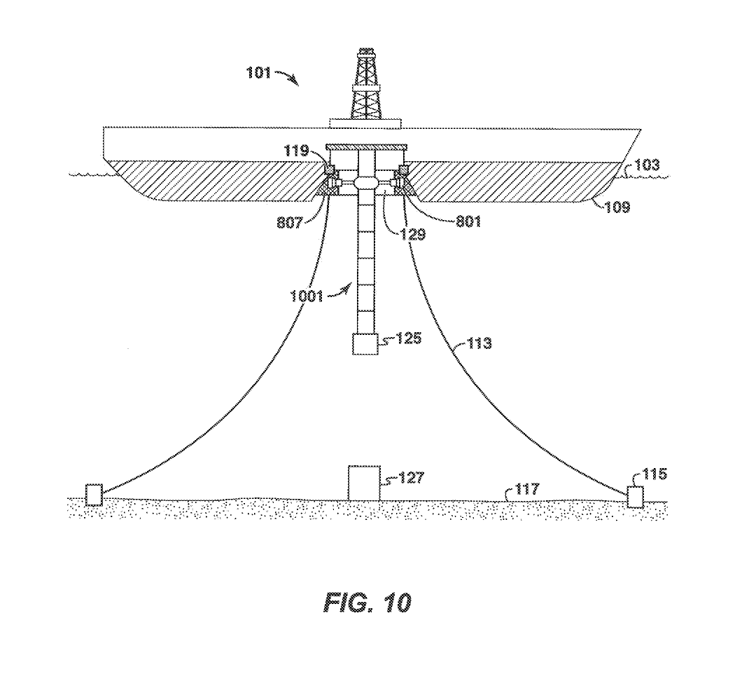

FIG. 10 is a cross-sectional side view of the drilling platform 101 of FIG. 9 in which a riser clamp 801 has been engaged according to one embodiment of the present disclosure. Once the appropriate amount of the riser has been retrieved, the riser clamp 801 is engaged to connect the remaining portion of the riser 1001 to the mooring buoy 807, thereby preventing the remaining riser portion 1001 to move freely relative to the mooring buoy 807. In some embodiments, once the clamp 801 is set, the riser spider which is normally used to support the upper most riser joint 805 at the drill floor may be removed. At this point, the remaining riser portion 1001 is only attached to the mooring buoy 807. In the depicted embodiment, riser clamp 801 comprises struts that span the gap between the walls of the buoy moon pool 129 and the remaining riser portion 1001. Because the riser clamp 801 is affixed to the mooring buoy 807, the engagement of the clamp struts and the proximate riser joint 805 fixedly attach the remaining riser portion 1001 to the buoy 807. In one embodiment, riser clamp 801 restrains both upward and downward vertical motion of the riser portion 1001 relative to the buoy 807.

Next, the locking mechanisms 119 of the mooring buoy 807 may be released thereby causing the buoy 807 and remaining riser portion 1001 to drop in the water 103. FIG. 11 is a cross-sectional side view of the drilling platform 101 of FIG. 10 in which the mooring buoy 807 has been released from the hull 109 according to one embodiment of the present disclosure. In one embodiment, the mooring buoy 807 drops to a depth sufficient to prevent contact of the buoy 807 and riser 1001 with the keels of ice ridges and icebergs that may be drifting overhead. Once the mooring buoy 807 has been released, the drilling platform 101 is then free to drift away from the drilling site without any interference, as represented by arrow 1101. As depicted in FIG. 11, the remaining riser 1001 floats in the water column 103 with its lowest point, LMRP 125, clear of the BOP 127 which remains on the seabed 117.

The time required for disconnection of a marine riser according to embodiments of the present disclosure is the time required to retrieve a plurality joints at the top of the riser plus the time needed to release the buoy. However, the time required when utilizing embodiments of the present disclosure is significantly shorter than the overall time to disconnect and retrieve the entire riser. It is estimated that the time to disconnect the riser at the LMRP, retrieve a plurality of top joints to the platform, clamp the remaining riser portion to the mooring buoy and release the mooring buoy is of the order of 3 hours, much shorter than the estimated 20-hour time needed to disconnect and retrieve the entire riser in a water depth of 1000 m. Without embodiments of the present disclosure, the arrival of ice conditions capable of applying ice loads on the drilling vessel exceeding the mooring capacity would need to be forecasted 17 hours earlier than when embodiments of the present disclosure are utilized. The reduced window falls within existing ice detection, monitoring and forecasting capabilities, while the 20 hour window exceeds such capabilities.

Though not depicted (while maintaining use the reference numerals provided in FIGS. 8-11), the process is reversed for reconnection of the mooring buoy 807 and remaining riser 1001 for resumption of drilling operations once ice conditions improve at the drilling site. The buoy 807, including the riser 1001 clamped to it, is pulled up to and secured to the drilling platform 101 with the locking mechanisms 119. Following this step, the mooring lines 113 keep the drilling platform on station. The riser spider is properly placed on the drill floor in order to support the riser and the riser clamp 801 holding the riser is released. The previously removed joints (diverter, telescopic joint and other joints) are added to the riser. The total riser is then reconnected to the BOP 127 at the LMRP 125. The drilling platform 101 is then ready to resume drilling operations.

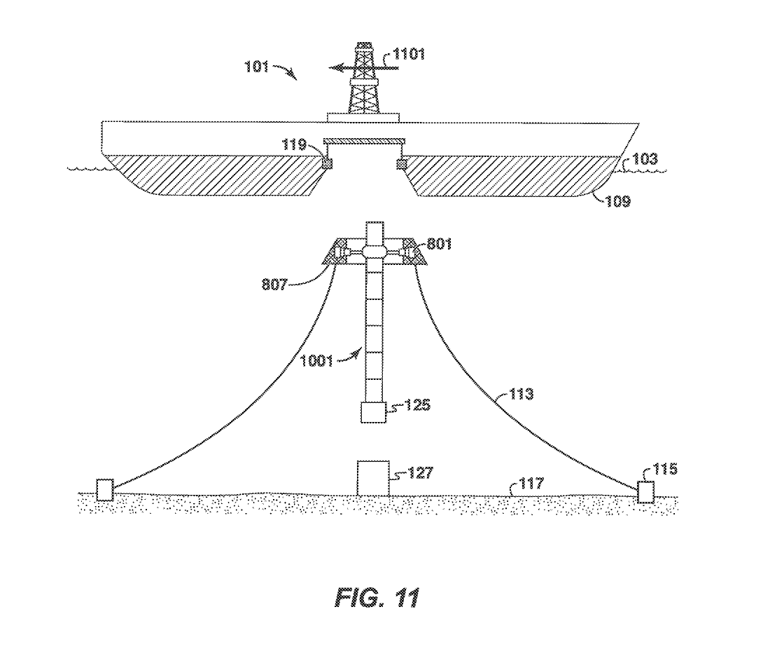

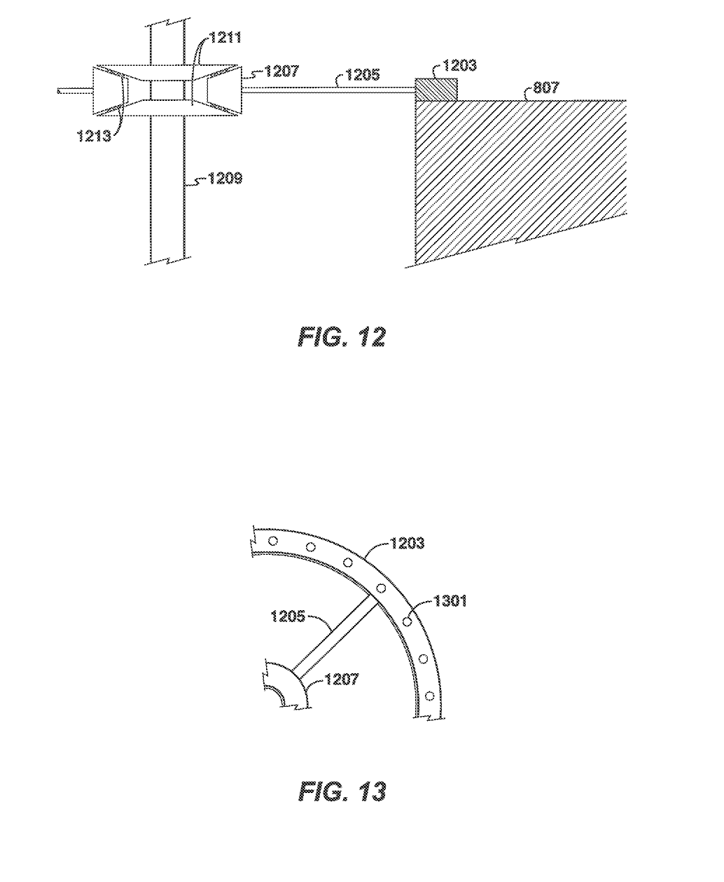

According to embodiments of the present disclosure, the mooring buoy is equipped with a clamp system for holding the riser. In some embodiments, the system consists of struts that span from the buoy and attach to the riser. FIG. 12 is a partial, cross-sectional side view of a clamp system 1201 according to one embodiment of the present disclosure. As depicted, a support frame 1203 attached to a mooring buoy 807. Strut 1205 is connected to frame 1203 on one end and on its opposite end has a mating member 1207.

In order to allow engagement with mating member 1207, riser joint 1209 is equipped with engagement members 1211. In one embodiment, engagement members 1211 are a pair of conical mating surfaces welded to riser joint 1209. In the depicted embodiment, impact pads 1213 are placed on engagement members 1211 in order to dampen the impact between mating member 1207 and engagement members 1211 when they engage after strut 1205 has been deployed. In other embodiment, impact pads may be affixed to the mating member. In one embodiment, strut 1205 is equipped with springs and/or hydraulic cylinders. In one embodiment, the clamp is deployed by releasing the springs and/or operating the hydraulic cylinders within strut 1205.

In the embodiment in which strut 1205 utilizes springs, the springs are compressed in order to put the mating member 1205 in a retracted position. Mating member 1207 is positioned closer to frame 1203 in its retracted position as compared to its deployed position. In the retracted position, mating member 1207 is positioned away from riser joint 1209 in order to allow engagement members 1211 to pass vertically by without any interference.

In one embodiment, when the riser needs to be attached to mooring buoy 801 for disconnection of the latter, the springs of strut 1205 are released and the mating member 1207 engages engagement members 1211 of riser joint 1209, thus firmly attaching the remaining riser to the buoy 807. In other embodiments, the hydraulic cylinders of strut 1205 are operated to move mating member 1207 between a retracted and deployed position. In the FIG. 12 embodiment, only a single riser joint 1209 is depicted. However, a plurality of riser joints may attached above and/or below riser joint 1209.

FIG. 13 is a partial top view of the riser clamp embodiment of FIG. 12. In the depicted embodiment, frame 1203 includes a plurality of attachment apertures 1301 which allow the frame to be connected to the mooring buoy using known mechanisms or devices. In some embodiments, frame 1203 may be welded to the mooring buoy. In the embodiment depicted in FIG. 12, frame 1203 provided at the top of buoy 807. In other embodiments, frame 1203, as well as the associated equipment, may be provided at any position along the interior or bottom of the buoy 807. In some embodiments, multiple frames and associated struts may be utilized.

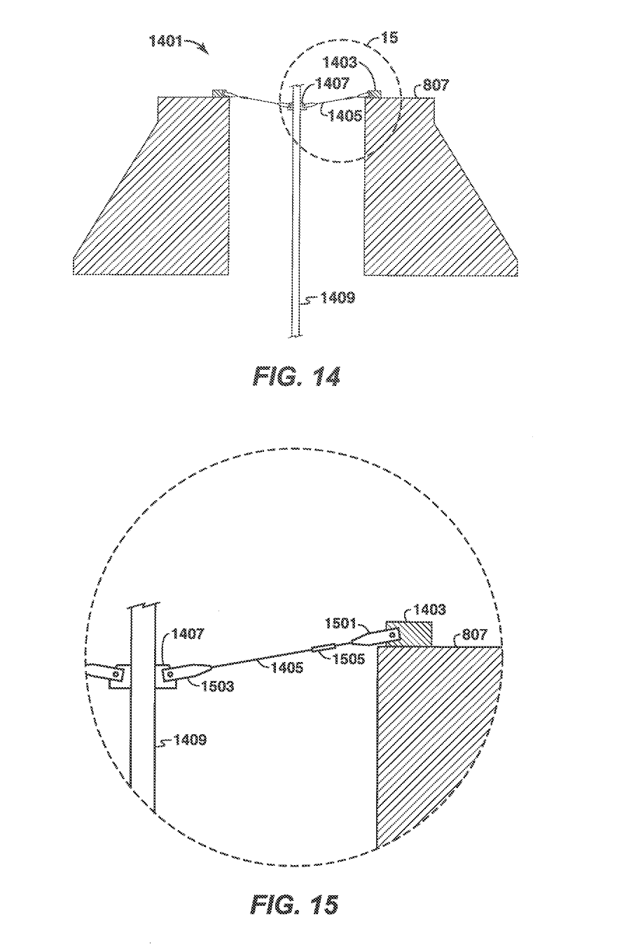

FIG. 14 is a cross-sectional side view of a riser clamp according to a further embodiment of the present disclosure. FIG. 15 is an enlarged, partial side view of the riser clamp embodiment of FIG. 14. In the embodiment depicted in FIGS. 14 and 15, clamp system 1401 utilizes a tension clamp design. A buoy attachment 1403 is affixed to mooring buoy 807 and a riser attachment 1407 is affixed to riser 1409. When the riser needs to be attached to the mooring buoy 807, a strut 1405 is attached to buoy attachment 1403 and riser attachment 1407. In one embodiment, the strut 1405 is a steel wire, though other tension members may be used. Several such strut arrangements may be provided radially around the moon pool to provide adequate restraint to the riser.

As more clearly demonstrated in FIG. 15, strut 1405 is connected to buoy attachment 1405 via a first connector 1501 and to riser attachment 1407 via a second connector 1503. In some embodiments, first connector 1501 and second connector 1503 are constructed and arranged to allow for rotation relative to the attachment points. Strut 1405 is also equipped with a turnbuckle 1505, or other type of tensioner known in the art. Turnbuckle 1505 is operatively connected to strut 1405 to allow for the tension within the strut to be increased or decreased. In some embodiments, once the strut 1405 is connected to the buoy 807 and the riser 1409, strut 1405 tension is increased to a required level in order to adequately restrain relative motion of the riser and the buoy. In some embodiments, additional attachments and struts may be provided at various levels of the riser joint and/or mooring buoy to prevent rotation of the riser relative to buoy, as well as translation.

The following lettered paragraphs represent non-exclusive ways of describing embodiments of the present disclosure.

A. A method for disconnecting a drilling riser of a floating drilling platform, the floating drilling platform having a mooring buoy connected to a seabed, the method comprising: disconnecting the drilling riser from a subsea component engaged to the seabed; attaching the mooring buoy to the drilling riser; and releasing the mooring buoy and the attached drilling riser from the drilling platform.

A1. The method of paragraph A1 further comprising retrieving a first number of riser joints, wherein before disconnection from the subsea component the drilling riser is comprised of a second number of riser joints, the first number of riser joints is less than the second number of riser joints.

A2. The method of any preceding paragraph, wherein the subsea component is a blowout preventer.

A3. The method of any preceding paragraph, wherein the mooring buoy is attached to the drilling riser by releasing a compression clamp.

A4. The method of paragraph A3, wherein the compression clamp comprises a strut extending from the mooring buoy to a riser joint and a mating member which engages a pair of conical surfaces affixed to the riser joint when the compression clamp is released.

A5. The method of paragraph A1, A2 or A3, wherein the mooring buoy is attached to the drilling riser by connecting a tension strut to a riser joint and the mooring buoy.

A6. The method of paragraph A5 further comprising adjusting a turnbuckle operatively connected to the tension strut in order to tighten the tension strut.

A7. The method of any preceding paragraph, wherein the mooring buoy has a moon pool and the drilling riser is positioned within the moon pool.

B. A system for disconnecting a drilling riser from a floating drilling platform, the system comprising: a mooring buoy releasably connected to a hull of the floating drilling platform by at least one buoy locking mechanism, the mooring buoy is connected to a seabed by a plurality of mooring lines; and a clamp system attached to an exterior surface of the mooring buoy, wherein the clamp system has a disengaged position which allows the drilling riser to freely move relative to the mooring buoy, the clamp system has an engaged position which prevents the drilling riser to freely move relative to the mooring buoy, the clamp system is constructed and arranged to maintain the engaged position after the mooring buoy has been released from the hull of the floating drilling platform.

B1. The system of paragraph B, wherein the clamp system comprises a compression clamp.

B2. The system of paragraph B1, wherein the compression clamp comprises a strut connected on a first end to a frame which is affixed to the mooring buoy and a mating member attached to a second end of the strut, wherein the mating member is constructed and arranged to engage a pair of conical surfaces affixed to a riser joint when the clamp system is in the engaged position.

B3. The system of paragraph B1, wherein an impact pad is attached to the interior surface of at least one of the conical surfaces.

B4. The system of any preceding paragraph, wherein the strut is hydraulically operated.

B5. The system of any preceding paragraph, wherein the strut is equipped with springs.

B6. The system of paragraph B, wherein the clamp system comprises a buoy attachment affixed to the mooring buoy, a riser attachment affixed to a riser joint, and a tension strut constructed and arranged to attach to the buoy attachment and the riser attachment when the clamp system is in the engaged position.

B7. The system of paragraph B6, wherein the tension strut comprises a turnbuckle operatively connected to the tension strut.

B8. The system of any preceding paragraph, wherein the mooring buoy has a moon pool and the drilling riser is positioned within the moon pool.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

1. A method for disconnecting a drilling riser of a floating drilling platform, the floating drilling platform having a mooring buoy connected to a seabed, the method comprising:
disconnecting the drilling riser from a subsea component engaged to the seabed;
attaching the mooring buoy to the drilling riser; and
releasing the mooring buoy and the attached drilling riser from the drilling platform.

2. The method of claim 1 further comprising retrieving a first number of riser joints, wherein before disconnection from the subsea component the drilling riser is comprised of a second number of riser joints, the first number of riser joints is less than the second number of riser joints.

3. The method of claim 1, wherein the subsea component is a blowout preventer.

4. The method of claim 1, wherein the mooring buoy is attached to the drilling riser by releasing a compression clamp.

5. The method of claim 4, wherein the compression clamp comprises a strut extending from the mooring buoy to a riser joint and a mating member which engages a pair of conical surfaces affixed to the riser joint when the compression clamp is released.

6. The method of claim 1, wherein the mooring buoy is attached to the drilling riser by connecting a tension strut to a riser joint and the mooring buoy.

7. The method of claim 6 further comprising adjusting a turnbuckle operatively connected to the tension strut in order to tighten the tension strut.

8. The method of claim 1, wherein the mooring buoy has a moon pool and the drilling riser is positioned within the moon pool.

9. A system for disconnecting a drilling riser from a floating drilling platform, the system comprising:
a mooring buoy releasably connected to a hull of the floating drilling platform by at least one buoy locking mechanism, the mooring buoy is connected to a seabed by a plurality of mooring lines; and
a clamp system attached to an exterior surface of the mooring buoy, wherein the clamp system has a disengaged position which allows the drilling riser to freely move relative to the mooring buoy, the clamp system has an engaged position which prevents the drilling riser to freely move relative to the mooring buoy, the clamp system is constructed and arranged to maintain the engaged position after the mooring buoy has been released from the hull of the floating drilling platform.

10. The system of claim 9, wherein the clamp system comprises a compression clamp.

11. The system of claim 10, wherein the compression clamp comprises a strut connected on a first end to a frame which is affixed to the mooring buoy and a mating member attached to a second end of the strut, wherein the mating member is constructed and arranged to engage a pair of conical surfaces affixed to a riser joint when the clamp system is in the engaged position.

12. The system of claim 11, wherein an impact pad is attached to the interior surface of at least one of the conical surfaces.

13. The system of claim 11, wherein the strut is hydraulically operated.

14. The system of claim 11, wherein the strut is equipped with springs.

15. The system of claim 9, wherein the clamp system comprises a buoy attachment affixed to the mooring buoy, a riser attachment affixed to a riser joint, and a tension strut constructed and arranged to attach to the buoy attachment and the riser attachment when the clamp system is in the engaged position.

16. The system of claim 15, wherein the tension strut comprises a turnbuckle operatively connected to the tension strut.

17. The system of claim 9, wherein the mooring buoy has a moon pool and the drilling riser is positioned within the moon pool.
